(19) United States
(12) Patent Application Publication
(10) Pub. No.: US 2008/0132346 A1
(43) Pub. Date: Jun. 5, 2008

(54) Cue stick shaft

(75) Inventors: Paul D. Costain, Lakeland, FL (US); Stephen Titus, Daytona Beach, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: CLAWSON CUSTOM CUES, INC., Jacksonville, FL (US)

(21) Appl. No.: 11/978,546

(22) Filed: Oct. 29, 2007

Related U.S. Application Data
(60) Provisional application No. 60/856,097, filed on Nov. 2, 2006.
(60) Provisional application No. 60/959,740, filed on Jul. 16, 2007.

(51) Int. Cl. A63D 15/08; G01N 3/20

(52) U.S. Cl. 473/44; 209/518; 73/849; 209/592

(57) ABSTRACT

A method and apparatus for forming a cue stick member is disclosed. A stiffness characteristic S_{f} factor for a series of wood strips can be tested and determined. The wood strips that have matching stiffness characteristic factors S_{f} can be selected within a predetermined tolerance for laminating together.

### RELATED APPLICATION(S)

This application claims the benefit of U.S. Provisional Application No. 60/856,097, filed on Nov. 2, 2006 and U.S. Provisional Application No. 60/959,740, filed on Jul. 16, 2007. The entire teachings of the above application(s) are incorporated herein by reference.

### BACKGROUND

Shafts for cue sticks are sometimes formed from a number of pieces of wood, usually having a triangle cross section, that are laminated together, and turned on a lathe. In order for the shaft to perform consistently, it is desirable for the pieces of wood laminated in a shaft to come from the same board of wood and have similar properties. Forming a shaft from pieces of wood cut from different boards, or from pieces of wood from the same board that have different properties, typically results in a shaft that performs inconsistently.

### SUMMARY

The present invention can provide a method of forming a cue stick member including testing and determining stiffness characteristic factors S_{f} for a series of wood strips, and selecting the wood strips that have matching stiffness characteristics factors S_{f} within a predetermined tolerance for laminating together.

In particular embodiments, the cross sectional height of the wood strips can be measured with a height measuring device. A predetermined load can be applied on the wood strips and the amount of deflection of the wood strips while under load can be measured with a deflection measuring device. The stiffness characteristic factors S_{f} for the wood strips can be calculated with a processor as a function of measured cross sectional height and measured deflection. The stiffness characteristic factors S_{f} can be calculated by the equation

$${S}_{f} = {( \frac{h}{{h}_{avg}} )}^{4} D$$

where h=cross sectional height, h_{avg}=average cross sectional height, and D=measured deflection. Wood strips can be selected that have stiffness characteristic factors S_{f} within about 10% variation. In some embodiments, wood strips are selected that have stiffness characteristic factors S_{f} within about a 6% variation, and in some cases, within about a 4% variation. The weight of the wood strips can be measured with a weighing device. Weight characteristic factors W_{f} can be calculated with a processor as a function of measured cross sectional height and measured weight. Wood strips can be selected that have matching stiffness and weight characteristic factors S_{f} and W_{f} within a predetermined tolerance. The weight characteristic factors W_{f} can be calculated by the equation

$${W}_{f} = {( \frac{{h}_{avg}}{h} )}^{2} W$$

where h=cross sectional height, h_{avg}=average cross sectional height, and W=measured weight. Wood strips can be selected that have stiffness and weight characteristic factors S_{f} and W_{f} within about a 10% variation. In some embodiments, wood strips can be selected that have stiffness and weight characteristic factors S_{f} and W_{f} within about 6% variation, and in some cases, within about a 4% variation. The wood strips can be formed to have a generally triangular cross section where h=triangle height, and h_{avg}=average triangle height. Wood strips can be selected to have a measure of hardness within about a 4% variation.

The present invention can also provide a cue stick member including wood strips that are laminated together. The wood strips can be selected to have stiffness characteristic factors S_{f} that are tested to be within about a 4% variation.

In particular embodiments, the stiffness characteristic factors S_{f} are a function of measured cross sectional height and deflection of the wood strips. The stiffness characteristic factors S_{f} can be calculated with the equation

$${S}_{f} = {( \frac{h}{{h}_{avg}} )}^{4} D$$

where h=cross sectional height, h_{avg}=average cross sectional height, and D=measured deflection. The wood strips can have matching weight characteristic factors W_{f} within a predetermined tolerance which are a function of measured cross sectional height and measured weight of the wood strips. The weight characteristic factors W_{f} can be calculated with the equation

$${W}_{f} = {( \frac{{h}_{avg}}{h} )}^{2} W$$

where h=cross sectional height, h_{avg}=average cross sectional height, and W=measured weight. The wood strips can have weight characteristic factors W_{f} within about a 10% variation. In some of the embodiments, the wood strips can have weight characteristic factors W_{f} that are within about a 6% variation, and in some case, within about a 4% variation. The wood strips can have a generally triangular cross section where h=triangle height and h_{avg}=average triangle height. The wood strips can have a measure of hardness within about a 4% variation.

The present invention can also provide an apparatus for selecting wood strips for a cue stick member which includes a height measuring device for measuring cross sectional height of the wood strips. A loading device can apply a predetermined load on the wood strips at a predetermined location for deflecting the wood strips. A deflection measuring device can measure deflection of the wood strips at a predetermined location while under load. A processor can calculate stiffness characteristic factors S_{f} for the wood strips as a function of measured cross sectional height and measured deflection, and select wood strips that have matching stiffness characteristic factors S_{f} within a predetermined tolerance.

In particular embodiments, the processor can calculate the stiffness characteristic factors S_{f} with the equation

$${S}_{f} = {( \frac{h}{{h}_{avg}} )}^{4} D$$

where h=cross sectional height, h_{avg}=average cross sectional height, and D=measured deflection. The processor can match wood strips that have stiffness characteristic factors S_{f} within about a 10% variation. In some embodiments, the processor can match wood strips that have stiffness characteristic factors S_{f} within about a 6% variation, and in some cases, within about a 4% variation. A weighing device can measure weight of the wood strips. The processor can calculate weight characteristic factors W_{f} as a function of measured cross sectional height and measured weight, and select wood strips having matching stiffness and weight characteristic factors S_{f} and W_{f} within a predetermined tolerance. The processor can calculate the weight characteristic factor W_{f} with the equation

$${W}_{f} = {( \frac{{h}_{avg}}{h} )}^{2} W$$

where h=cross sectional height, h_{avg}=average cross sectional cross sectional height, and W=measured weight. The processor can match wood strips that have stiffness and weight characteristic factors S_{f} and W_{f} within about a 10% variation. In some embodiments, the processor can match wood strips that have stiffness and weight characteristic factors S_{f} and W_{f} within about a 6% variation, and in some cases, within about a 4% variation. The apparatus can measure the properties of wood strips having a generally triangular cross section, where h=triangle height and h_{avg}=average triangle height. The processor can match wood strips that have a measure of hardness within about a 4% variation.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a side view of an embodiment of a cue stick in accordance with the present invention.

FIG. 2 is a perspective view of an embodiment of a blank for a shaft in the present invention.

FIG. 3 is a flow chart showing a method for forming a blank in the present invention.

FIG. 4 is a flow chart showing a method for matching wood laminate strips in the present invention.

FIG. 5 is a schematic drawing of an embodiment of an apparatus for matching wood laminate strips in the present invention.

FIGS. 6 and 7 are perspective views of various pieces of equipment for making measurements for the apparatus of FIG. 5.

### DETAILED DESCRIPTION

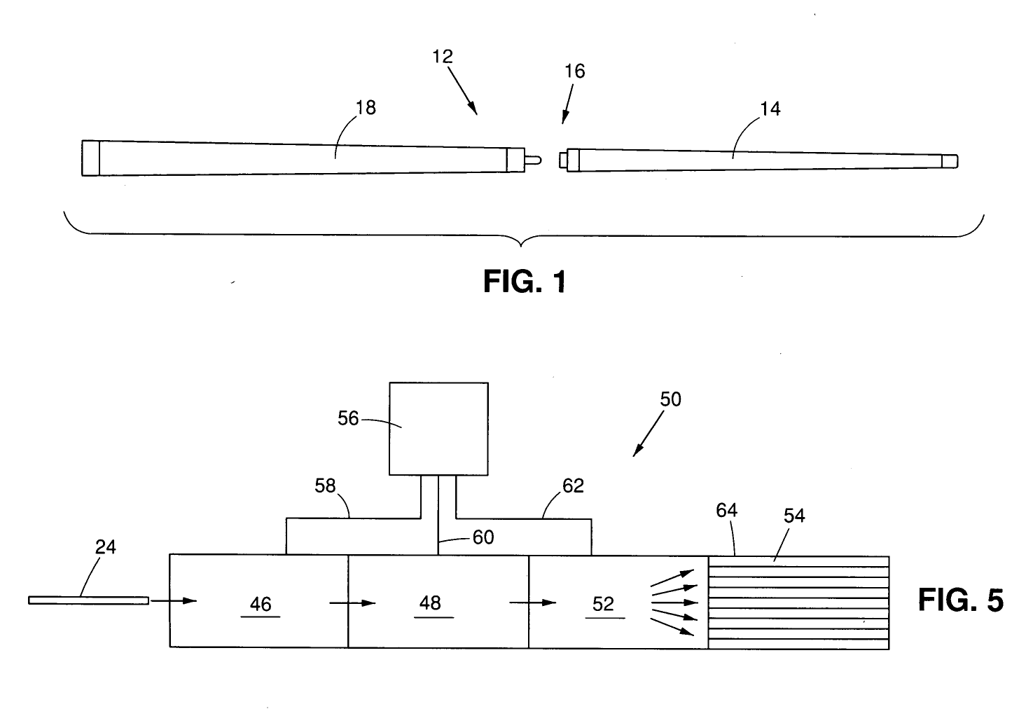

Referring to FIG. 1, in one embodiment of the present invention, cue stick 12 can include shaft portions, or cue stick portions, such as a butt 18 and a front shaft 14. The butt 18 and the shaft 14 can be secured together by a suitable joint such as a threaded joint 16. In some embodiments, the joint 16 can, for example, joints such as shown and described in U.S. Pat. Nos. 6,348,006 and 6,783,462, as well as patent application Ser. No. 11/409,509, filed Apr. 21, 2006, the teachings of which are incorporated herein by reference in their entirety.

Referring to FIG. 2, the shaft 14 and the butt 18 can be formed from a blank 22. The blank 22 as well as the shaft portions or cue stick portions, such as the butt 18 and front shaft 14, can be broadly described as being cue stick components or members. The following description mostly describes forming the front shaft 14, but it is understood that other stick or shaft portions such as the butt 18 can be made in a similar manner. The blank 22 can be formed from a number of elongate wood pieces or strips 24, that are laminated together. The wood strips 24 can be made of maple, or other suitable woods. Each wood strip 24 can have a length and a generally isosceles triangle cross section with a base “b” and a height “h”. In one embodiment, the cross sectional base “b” can be about 5/16 inches and the cross sectional height “h” can be about 7/16 inches. Ten triangular wood strips 24 (1-10) can be laminated together. In other embodiments, less than ten or more than ten triangular wood strips 24 can be laminated together, and the shape and/or dimensions of the triangle cross section can be varied. Alternatively, the wood strips 24 can have other cross sectional shapes, such as square, rectangular, hexagonal, etc. The description mostly describes employing triangular wood strips 24, but it is understood that wood strips having other cross sectional shapes can be employed. The dimension “h” in such shapes can be the cross sectional height or thickness.

As previously mentioned, it is common practice in the prior art to form a blank from wood strips that are cut from the same board and have similar properties. Although, there are often wood strips from a board that are left over, it has not been desirable to use the left over wood strips to form a blank, and therefore, the extra wood strips become scrap. A reason for this is that the use of scrap wood strips can result in a cue stick shaft having wood strips from one board on one side, and wood strips from one or more other boards having different properties on the other side or other locations. Such a shaft made from scraps, can perform inconsistently. For example, a cue ball can behave differently when struck, depending upon the rotational position of the shaft (the side facing up).

The Applicants have discovered through testing that the stiffness of maple wood typically used for blank 22 can vary about 40% and the density can vary about 20%, therefore resulting in varying properties between different boards. Also, some boards can have varying properties at different locations of the same board, where the stiffness and density in a single board can sometimes vary as much as 5%. In addition, through testing, the Applicants have found that a shaft 14 having wood strips 24 with matching stiffness provides better or more consistent performance. Furthermore, the Applicants have found that a blank 22 having wood strips 24 with matching hardness can be manufactured more consistently, and can also contribute to better or more consistent performance. For example, having wood strips 24 with matching hardness characteristics allows the blank 22 to be turned on a lathe more uniformly than a blank 22 having both hard and soft wood strips 24. A blank 22 with both hard and soft wood strips 24 can result in a non-uniformly cut shaft 14, and can provide inconsistent performance.

Accordingly, the Applicants have come up with a method and apparatus for testing and matching wood strips 24 cut from any board for forming a blank 22. This allows use of left over wood strips 24 cut from different boards. This can also allow wood strips 24 that are cut from a single board but have very different properties to be matched in different blanks 22. In addition, as a result, in some instances, it is possible to form a blank 22 from wood strips 24 that are more closely matched than if formed from wood strips 24 from the same board.

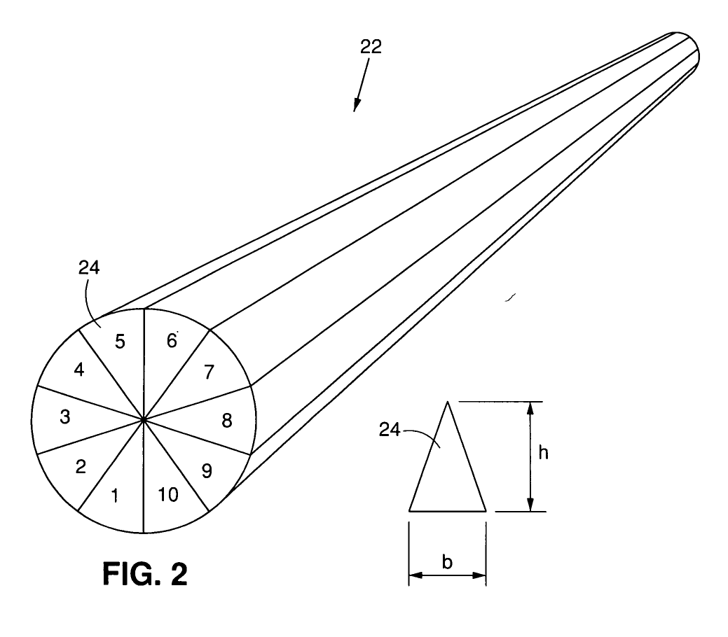

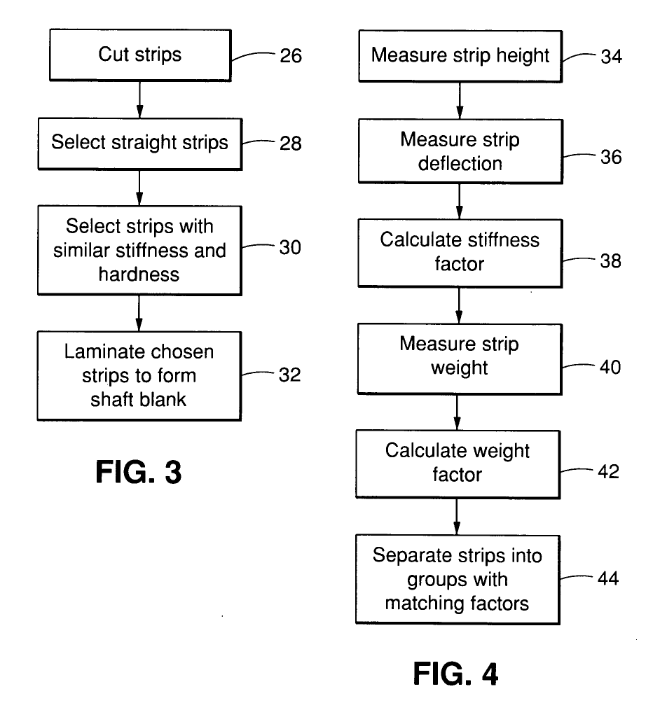

Referring to FIG. 3, in one method of making a blank 22, wood strips 24 in step 26 can be cut from one, or a series of maple boards. The wood strips 24 can have a generally isosceles triangle cross section such as seen in FIG. 2. In step 28, wood strips 24 that are straight, or relatively straight within a desired tolerance, can be selected for further processing. In step 30, each wood strip 24 can be physically tested, examined, evaluated, or measured. Wood strips 24 with similar or matching properties can be selected for separation into matching groups, for example, wood strips 24 that have similar or matching stiffness properties, characteristics or factors within a desired range or tolerance. In combination with stiffness characteristics, the wood strips 24 can also be selected that have similar or matching hardness properties, characteristics or factors. Matching wood strips 24 from selected groups can then be laminated together in step 32 to form blanks 22. Each blank 22 can include wood strips 24 on all sides, circumference, or rotational angular position, having properties including stiffness and hardness characteristics that are within a particular predetermined range or tolerance of each other. When the laminated blank 22 is turned on a lathe and formed into a shaft 14, the wood of the shaft 14 can have relatively consistent properties on all sides of the shaft 14, thereby providing generally consistent striking of a cue ball regardless of the rotational positioning of the shaft 14.

One method of selecting or matching wood strips 24 with similar or matching properties is shown in FIG. 4. In step 34, the height of each wood strip 24 can be measured at a dimensional measuring station 46 of selection apparatus 50 (FIG. 5), for example, the cross sectional height “h” of a triangle cross section wood strip 24 can be measured to the closest 1/1000 of an inch. A processor 56 in communication with the dimensional measuring station 46 via line 58 can store the measured height “h” values in memory. If desired, processor 56 can control the operation of the dimensional measuring station 46.

In step 36, each wood strip 24 can be subjected to a load, and the amount of deflection “D”, can be measured at a deflection measuring station 48. The deflection values “D” can be stored in the memory of processor 56. The processor 56 is in communication with deflection measuring station 48 via line 60 and can control the operation of the deflection measuring station 48 if desired. In one embodiment, to measure deflection “D”, the wood strips 24 can be clamped into one end, and with the cantilevered end being subjected to a load, the amount of deflection “D” can be measured for example, to the closest 1/10 of a gram. The load can be a predetermined amount that is applied at a predetermined location, and the amount of deflection can be measured at a predetermined location. In one example, the wood strip 24 can be cantilevered about 11½ inches with a weight of about 17 ounces (for example 16.95 ounces) being hung or applied about ⅛ inches from the end, and the deflection “D” being measured at about 8 5/16 inches on the cantilevered length of the wood strip 24. In other embodiments, these dimensions and weights or loads can be varied to fit the situation at hand. In addition, the wood strips 24 can be supported at opposite ends and deflected in the middle. Furthermore, the weight can be substituted by a force generating member, such as a mechanical, electronic, fluid or pneumatic activated member that can provide a controlled predetermined amount of force on the wood strip 24 to deflect the wood strip 24.

In step 38, based on stored measured values of the cross sectional height “h” and deflection “D” of the wood strips 24, processor 56 can calculate and store in memory a value of deflection or stiffness, such as a deflection or stiffness characteristic factor S_{f} for each wood strip 24 using Equation 1 as follows:

$${S}_{f} = {( \frac{h}{{h}_{avg}} )}^{4} D \qquad ( Equation 1 )$$

where:

h=Triangle cross sectional height

h_{avg}=Average triangle cross sectional height

D=Measured deflection

The stiffness characteristic factor S_{f} can compensate for dimensional differences in the height “h” of the wood strips 24 which can affect the value of the measured deflection for a particular wood strip 24. The average cross sectional height “h_{avg}” is the average cross sectional height of measured wood strips 24, and can be calculated using previously stored values of measured cross sectional heights “h”, and is a factor in compensating for dimensional differences “h” of the wood strips 24 when calculating the stiffness characteristic factor S_{f} of each wood strip 24. The average cross sectional height “h_{avg}” can be recalculated for each wood strip 24, or can be stored and recalculated periodically. In some embodiments, wood strips can be employed that are not triangular in shape, for example, rectangular, square, hexagonal, etc., and the stiffness characteristic factor S_{f} can be calculated using dimensions “h” and “h_{avg}” that can be the cross sectional height or thickness of such shapes. The stiffness characteristic factor S_{f} calculated with Equation 1 is a function of measured cross sectional height, stored or calculated average cross sectional height, and deflection of wood strips 24. However, it is possible to physically test, examine, evaluate or measure other properties, and calculate other stiffness characteristic factors S_{f} using such properties. In addition, non contact testing or evaluating can be performed, for example, spectroscopy analysis. In some embodiments, the modulus of elasticity, tensile strength, or yield strength of the wood strips 24 can be determined and used as a stiffness characteristic S_{f}.

In step 40, the weight “W” of each wood strip 24 can be weighed at weighing station 52. The processor 56 is in communication with the weighing station 52 via line 62 and can store the measured weight “W” of each wood strip 24 in memory. The processor 56 can also control the operation of the weighing station 52 if desired.

In step 42, based on stored measured values of the cross sectional height “h” and weight “W”, processor 56 can calculate and store in memory a value of density or weight, such as a weight characteristic factor W_{f} for each wood strip 24 using Equation 2 as follows:

$${W}_{f} = {( \frac{{h}_{avg}}{h} )}^{2} W \qquad ( Equation 2 )$$

where:

h=Triangle cross sectional height

h_{avg}=Average triangle cross sectional height

W=Measured weight.

The weight characteristic factor W_{f} can compensate for dimensional differences in the height “h” of the wood strips 24 which can affect the value of the measured weight. The calculated average cross sectional height “h_{avg}” is a factor in compensating for dimensional differences “h” of the wood strips 24 when calculating the weight characteristic factor W_{f} of each wood strip 24. In some embodiments, wood strips can be employed that are not triangular in shape, for example, rectangular, square, hexagonal, etc., and the weight characteristic factor W_{f} can be calculated using dimensions “h” and “h_{avg}” that can be the cross sectional height or thickness of such shapes.

The Applicants have found through testing, that for maple, density or weight, and hardness are related. As a result, the denser or heavier the wood strip 24, the harder the wood strip 24. Consequently, the weight characteristic factor W_{f} can be used as a relative measurement of density and hardness for the wood strips 24. The weight characteristic factor W_{f} calculated with Equation 2 is a function of measured cross sectional height, stored or calculated average cross sectional height, and weight of wood strips 24, however, in other embodiments, other methods of measuring hardness can be performed for example, relative hardness testing, can be used for selecting and matching wood strips 24. A typical hardness range for maple can be 65-75 hardness. Additionally Brinell and Rockwell type hardness tests can be performed. Furthermore, actual density values can be calculated and used as a weight characteristic factor W_{f} for selecting and matching wood strips 24.

In step 44, the wood strips 24 can be graded, selected, separated or categorized into matching groups or categories, for example, in a series of separate bins or storage areas 54 at grading, selection, separation or categorization station 64, based on matching properties, characteristics or factors stored in processor 56. In some embodiments, the wood strips 24 can be marked with an appropriate marking such as a stamp indicating a particular grading or category. The blanks 22 can be laminated from matching wood strips 24 from particular grades or categories, and can be from particular bins 54, or each bin 54. The wood strips 24 can be separated or selected into matching groups or categories based upon matching values for the stiffness characteristic factor S_{f}. Typically, the values of a matching group for a particular blank 22 should have stiffness characteristic factor values S_{f} that are within a tolerance of about a 10% variation, and more preferably within about 6%. Variations less than 6% can be chosen, and variations within about 4%, are desirable. Although variations less than 4% are possible, for example about 2%, it can be less practical.

In addition, values representing density or hardness such as the weight characteristic factor W_{f} can be used in combination with the stiffness characteristic factor S_{f} for separation or selection into matching groups or categories. The values for density or hardness such as the weight characteristic factors W_{f} in a matching group for a particular blank 22 should be within a tolerance of about a 10% variation and more preferably can be within about a 6% variation. Variations within about a 4% variation are desirable, and variations within about 2% are possible. Alternatively, other density or hardness measurements can be used. The wood strips 24 can be matched to have stiffness characteristic factors S_{f} and/or weight characteristic factors W_{f}, or other density or hardness measurements, that are within a certain tolerance of a predetermined base line value, or alternatively, can be matched to be merely within a certain tolerance relative to each other. If desired, separation station 64 can also use other factors for separation or selection in matching groups, including color and wood grain. This can be performed with an optical system, or alternatively, later by hand. Steps 26-44 can be performed automatically, manually, or a combination of both.

Shafts 14 can be made to include wood strips 24 with stiffness characteristic factors S_{f} and density, hardness or weight characteristic factors W_{f} that are within a tolerance of about a 4° variation, and which can strike a cue ball over a distance of 50 inches consistently within a 0.040 inch deflection or drift tolerance while striking the cue ball at a 0.4 inch offset from center, regardless of the rotational position of the shaft 14 (side facing up).

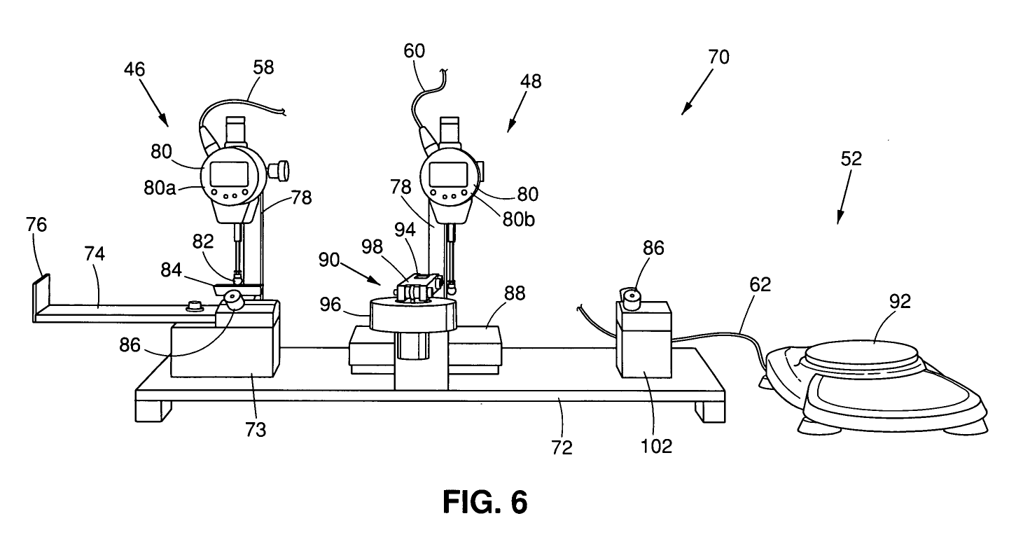

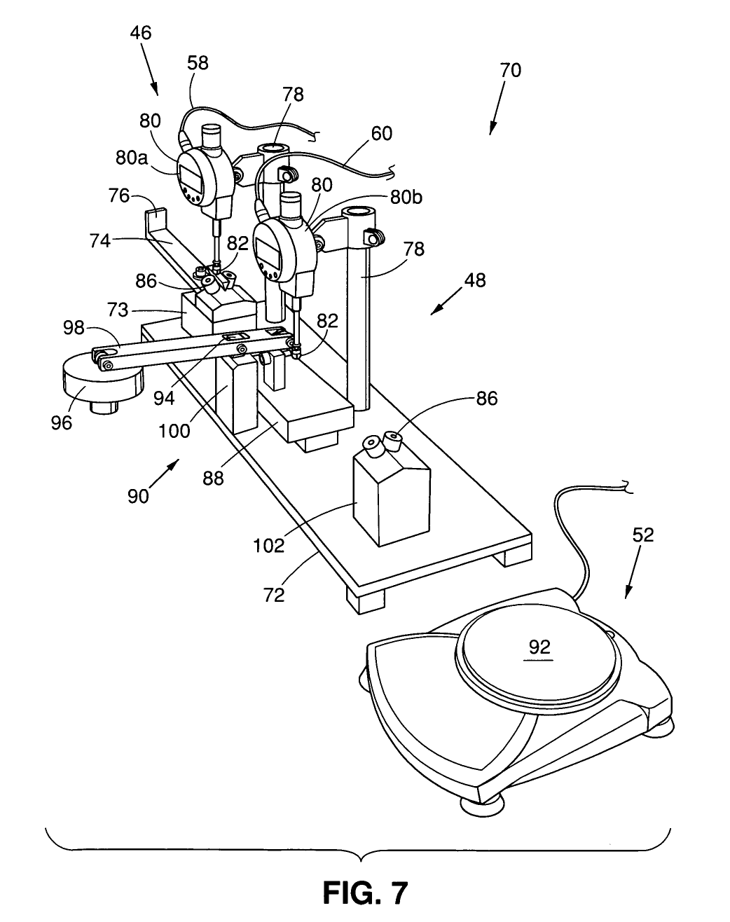

FIGS. 6 and 7 depict various pieces of equipment 70 for making measurements for selection apparatus 50. Measuring station 46 can include a fixture 73 having a horizontal support surface 74 and an end stop 76 for supporting the wood strips 24 in position for measuring. The fixture 73 can be mounted to a base plate 72, and if desired, can include a clamp for securing the wood strips 24 in place. A height measuring device 80a can be mounted to a post 78 for measuring the cross sectional height “h” of the wood strips 24. The height measuring device 80a can be a measuring device 80 such as digital drop indicator and can include a roller type indicator tip 82 for contacting the wood strips 24, during measuring of the height “h”. Height measuring device 80a can be in communication with the processor 56 via line 58, for providing the processor 56 with measurements made by height measuring device 80a. In addition, if desired, the operation of height measuring device 80a can be controlled by processor 56 via line 58. A calibration member 84 can be included for calibrating the height measuring device 80a. Guides or guide rollers 86 can be included, one on fixture 73 and the other mounted to base 72 on a fixture 102 spaced apart from fixture 73 for aiding in the positioning of the wood strips 24. The guide rollers 86 can include a pair of rollers that are spaced apart and angled relative to each other for guiding wood strips 24 with a triangular cross section, in which the pointed edge faces downward.

Deflection measuring station 48 can include a loading or weighting device 90 having a predetermined amount of weight 88 which can be applied at a predetermined location on a wood strip 24 positioned on and cantilevered from the support surface 74 of fixture 73. The loading device 90 can include a counterweight 96 that is connected to the weight 88 by a pivoting arm 98 that is supported by a post 100. The counterweight 96 and the weight 88 can be connected to the arm 98 on opposite sides of a pivot point 94 on post 100, about which arm 98 pivots. The weight 88 and/or the counterweight 96 can be adjusted to provide the desired load. The wood strips 24 can be deflected by loading device 90 between fixtures 73 and 102 while being supported by one or both sets of the guide rollers 86. In some embodiments, the loading device 90 can deliver a predetermined load by other means, such as with a mechanical, electronic, fluid, pneumatic, etc., force generating number. Some examples, include linkages, levers, cams, cylinders, rotational and linear actuators, motors, servo motors, etc.

A deflection measuring device 80b can be mounted to a post 78 for measuring the amount of deflection of wood strips 24 loaded by loading device 90. The deflection measuring device 80b can be a measuring device 80 such as a digital drop indicator which can contact the deflected surface of the wood strips 24 at the desired location. Deflection measuring device 80b can be in communication with the processor 56 via line 60, for providing the processor 56 with measurements made by deflection measuring device 80b. In addition, if desired, the operation of deflection measuring device 80b can be controlled by processor 56 via line 58. Furthermore, the loading device 90 can be connected to and controlled or operated by processor 56. In some embodiments, the wood strips 24 can be deflected a predetermined amount and the load required to obtain such deflection can be measured. Although an example of measuring devices 80 has been given as digital drop indicators, it is understood that the other suitable measuring devices can be employed for making the desired measurements, and can include non contacting measuring devices, for example optical or laser measuring devices.

Weighing station 52 can include a scale 92 for weighing the wood strips 24. The scale 92 can be a separate component or can be incorporated into the measuring station 46 and/or the deflection measuring station 48. The scale 92 can be in communication with processor 56 via line 62 for providing processor 56 with measured weights, and if desired, can be controlled or operated by processor 56. In some embodiments, a hardness testing device can be employed to measure or test hardness of the wood strips 24, and if desired, can replace weighing station 52.

While this invention has been particularly shown and described with references to example embodiments thereof, it will be understood by those skilled in the art that various changes in form and details may be made therein without departing from the scope of the invention encompassed by the appended claims.

For example, the present invention can be used for making other sports sticks, such as hockey sticks, or other suitable shafts. Any multiple piece laminate can be formed with such a selection process. The present invention can also be used for woods other than maple, or for selecting and matching non-wood lamination strips. Also, the present invention can be used for selecting lamination strips or pieces having differing selected properties within desired tolerances for different parts or sides, for example, for a compound bow, where one portion is selected for compression properties and the other portion is selected for tensile properties. Although particular tolerances have been described for matching the wood strips, it is understood that other suitable tolerance limits can be employed.

What is claimed is:

1. A method of forming a cue stick member comprising:
testing and determining stiffness characteristic factors S_{f} for a series of wood strips; and
selecting the wood strips that have matching stiffness characteristic factors S_{f} within a predetermined tolerance for laminating together.

2. The method of claim 1 further comprising:
measuring cross sectional height of the wood strips with a height measuring device;
apply a predetermined load on the wood strips;
measuring deflection of the wood strips while under load with a deflection measuring device; and
calculating with a processor, the stiffness characteristic factors S_{f} for the wood strips as a function of measured cross sectional height and measured deflection.

3. The method of claim 2 further comprising calculating the stiffness characteristic factors S_{f} with the equation
$${S}_{f} = {( \frac{h}{{h}_{avg}} )}^{4} D$$
where h=cross sectional height, h_{avg}=average cross sectional height, and D=measured deflection.

4. The method of claim 3 further comprising selecting wood strips that have stiffness characteristic factors S_{f} within about a 10% variation.

5. The method of claim 3 further comprising selecting wood strips that have stiffness characteristic factors S_{f} within about a 6% variation.

6. The method of claim 3 further comprising selecting wood strips that have stiffness characteristic factors S_{f} within about a 4% variation.

7. The method of claim 3, further comprising:
measuring weight of the wood strips with a weighing device;
calculating with the processor, weight characteristic factors W_{f} for the wood strips as a function of measured cross sectional height and measured weight; and
selecting wood strips having matching stiffness and weight characteristic factors S_{f} and W_{f} within a predetermined tolerance.

8. The method of claim 7 further comprising calculating the weight characteristic factors W_{f} with the equation
$${W}_{f} = {( \frac{{h}_{avg}}{h} )}^{2} W ,$$
where h=cross sectional height, h_{avg}=average cross sectional height, and W=measured weight.

9. The method of claim 8 further comprising selecting wood strips that have stiffness and weight characteristic factors S_{f} and W_{f} within about a 10% variation.

10. The method of claim 8 further comprising selecting wood strips that have stiffness and weight characteristic factors S_{f} and W_{f} within about a 6% variation.

11. The method of claim 8 further comprising selecting wood strips that have stiffness and weight characteristic factors S_{f} and W_{f} within about a 4% variation.

12. The method of claim 8 further comprising forming the wood strips to have a generally triangular cross section, where h=triangle height, and h_{avg}=average triangle height.

13. The method of claim 6 further comprising selecting wood strips that have a measure of hardness within about a 4% variation.

14. A cue stick member comprising wood strips laminated together, the wood strips selected to have stiffness characteristic factors S_{f} tested to be within about a 4% variation.

15. The member of claim 14 in which the stiffness characteristic factors S_{f} are a function of measured cross sectional height and measured deflection of the wood strips.

16. The member of claim 15 in which the stiffness characteristic factors S_{f} are calculated with the equation
$${S}_{f} = {( \frac{h}{{h}_{avg}} )}^{4} D$$
where h=cross sectional height, h_{avg}=average cross sectional height, and D=measured deflection.

17. The member of claim 16 in which wood strips have matching weight characteristic factors W_{f} within a predetermined tolerance which are a function of measured cross sectional height and measured weight of the wood strips.

18. The member of claim 17 in which the weight characteristic factors W_{f} are calculated with the equation
$${W}_{f} = {( \frac{{h}_{avg}}{h} )}^{2} W$$
where h=cross sectional height, h_{avg}=average cross sectional height, and W=measured weight.

19. The member of claim 18 in which the wood strips have weight characteristic factors W_{f} that are within about a 10% variation.

20. The member of claim 18 in which the wood strips have weight characteristic factors W_{f} that are within about a 6% variation.

21. The member of claim 18 in which the wood strips have weight characteristic factors W_{f} that are within about a 4% variation.

22. The member of claim 18 in which the wood strips have a generally triangular cross section, where h=triangle height and h_{avg}=average triangle height.

23. The member of claim 14 in which the wood strips have a measure of hardness within about a 4% variation.

24. An apparatus for selecting wood strips for a cue stick member comprising:
a height measuring device for measuring cross sectional height of the wood strips;
a loading device for apply a predetermined load on the wood strips at a predetermined location for deflecting the wood strips;
a deflection measuring device for measuring deflection of the wood strips at a predetermined location while under load; and
a processor for calculating stiffness characteristic factors S_{f} for the wood strips as a function of measured cross sectional height and measured deflection, and selecting wood strips having matching stiffness characteristic factors S_{f} within a predetermined tolerance.

25. The apparatus of claim 24 in which the processor calculates the stiffness characteristic factors S_{f} with the equation
$${S}_{f} = {( \frac{h}{{h}_{avg}} )}^{4} D$$
where h=cross sectional height, h_{avg}=average cross sectional height, and D=measured deflection.

26. The apparatus of claim 25 in which the processor matches wood strips that have stiffness characteristic factors S_{f} within about a 10% variation.

27. The apparatus of claim 25 in which the processor matches wood strips that have stiffness characteristic factors S_{f} within about a 6% variation.

28. The apparatus of claim 25 in which the processor matches wood strips that have stiffness characteristic factors S_{f} within about a 4% variation.

29. The apparatus of claim 25 further comprising a weighing device for measuring weight of the wood strips, the processor calculating weight characteristic factors W_{f} as a function of measured cross sectional height and measured weight, and selecting wood strips having matching stiffness and weight characteristic factors S_{f} and W_{f} within a predetermined tolerance.

30. The apparatus of claim 29 in which the processor calculates the weight characteristic factors W_{f} with the equation
$${W}_{f} = {( \frac{{h}_{avg}}{h} )}^{2} W$$
where h=cross sectional height, h_{avg}=average cross sectional height, and W=measured weight.

31. The apparatus of claim 30 in which the processor matches wood strips that have stiffness and weight characteristic factors S_{f} and W_{f} within about a 10% variation.

32. The apparatus of claim 30 in which the processor matches wood strips that have stiffness and weight characteristic factors S_{f} and W_{f} within about a 6% variation.

33. The apparatus of claim 30 in which the processor matches wood strips that have stiffness and weight characteristic factors S_{f} and W_{f} within about a 4% variation.

34. The apparatus of claim 30 in which the apparatus measures the properties of wood strips having a generally triangular cross section, where h=triangle height and h_{avg}=average triangle height.

35. The apparatus of claim 28 in which the processor matches wood strips that have a measure of hardness within about a 4% variation.
